(19) United States
(12) Patent Application Publication
(10) Pub. No.: US 2025/0108664 A1
(43) Pub. Date: Apr. 3, 2025

(54) TIRE HAVING AN INNERLINER WITH A STEPPED RECESS AND METHOD OF CREATING A STEPPED RECESS ON AN INNER SURFACE OF A TIRE

(71) Applicant: The Goodyear Tire & Rubber Company, Akron, OH (US)

(72) Inventors: Thiago Martins Amaral, Ettelbruck (LU); Stephan Peter Hilger, Sankt Vith (BE); Thomas Salvo, Fauvillers (BE); Jason Mark Middelberg, Luxembourg (LU); Nicolas Soultis, Freylange (BE); Jeffrey McKay West, North Canton, OH (US)

(21) Appl. No.: 18/769,490

(22) Filed: Jul. 11, 2024

Related U.S. Application Data
(60) Provisional application No. 63/586,487, filed on Sep. 29, 2023.

(51) Int. Cl. B60C 5/14; B29D 30/06

(52) U.S. Cl. CPC B60C 5/14; B29D 30/06

(57) ABSTRACT

The invention is directed to a tire comprising an innerliner including a recess with a depth within a range of 20 μm to 3000 μm and a stepped sidewall, wherein at least one step of the recess' sidewall includes a height within a range of 5 μm to 1500 μm. Furthermore, the invention is directed to a method of processing a tire including an inner surface, wherein the method comprises creating a stepped recess in an area of the inner surface by removing a first thickness of elastomer composition in a first subarea, removing a second thickness of elastomer composition in a second subarea, wherein the second subarea at least partially overlaps with the first subarea so that a third thickness of elastomer composition is removed in an overlapping zone of the first subarea and the second subarea.

### FIELD OF THE INVENTION

The present invention is directed to a tire, particularly to a pneumatic tire, including an inner surface, particularly a surface of an innerliner, which comprises a stepped recess. Furthermore, the present invention is directed to a method of making and/or processing a tire, including creating a stepped recess in an inner surface of the tire, particularly in the surface of an innerliner of a pneumatic tire.

### BACKGROUND OF THE INVENTION

In addition to typical tire constructions, some modern tires comprise appliances or components, such as sensors integrated in or mounted to the tire. In some cases, such sensors are mounted to the tire after tire cure. Due to tire cure, substances such as mold release agents and/or other curing residues may remain on the tire's inner surface which impair attachment of components such as sensors. In order to improve post-cure attachment of components to tires, it is possible to clean the tires, e.g., by abrading a part of the tire's surface before mounting the component. However, it has been found that in some cases these abrasion processes may create stresses (though on a small scale) which might slightly impair sealing properties of a tire's innerliner. While improvements in conditioning tires for the attachment of additional components have been made in the past, significant room for improvement remains.

### SUMMARY OF THE INVENTION

In a first aspect, the present invention is directed to a tire comprising an innerliner including a surface facing a tire cavity, wherein the surface comprises a recess including i) a depth within a range of 20 μm to 3000 μm and ii) a stepped sidewall. Furthermore, at least one step of the sidewall of the recess includes a height within a range of 5 μm to 1500 μm.

In a second aspect, the present invention is directed to a method of processing a tire, wherein an inner surface of the tire is formed by an elastomer composition, and the method comprises creating a stepped recess in an area of the inner surface, wherein creating the recess further comprises removing a first thickness of the elastomer composition in a first subarea of the area of the inner surface, and removing a second thickness of the elastomer composition in a second subarea of the area of the inner surface. Furthermore, the second subarea at least partially overlaps with the first subarea in an overlapping zone so that in the overlapping zone a third thickness of the elastomer composition is removed as a result of removing the first thickness and the second thickness.

### BRIEF DESCRIPTION OF THE DRAWINGS

The invention will be described by way of example and with reference to the accompanying drawings in which:

FIG. 1 is a schematic cross-section of a tire in accordance with a preferred embodiment of the present invention, wherein the tire comprises a sensor container attached in a recess formed in the surface of an innerliner, radially below a tread portion of the tire;

FIG. 2 is a schematic plan view of a stepped recess in the surface of an innerliner, such as of the stepped recess shown in FIG. 1;

FIG. 3 is a schematic plan view of another stepped recess in an area of an inner surface of another tire, in accordance with another embodiment of the present invention;

FIG. 4a is a schematic plan view of a partially created recess in the area of the inner surface shown already in FIG. 2;

FIG. 4b is a schematic plan view of the recess already shown in FIG. 4a, which has been further deepened leaving a step in the recess' sidewall;

FIG. 4c is a schematic plan view of the recess already shown in FIGS. 4a and 4b, which has additionally been further deepened by leaving another step in its sidewall;

FIG. 4d is a schematic cross-section of the partial recess created in FIG. 4a;

FIG. 4e is a schematic cross-section of the stepped recess as present in FIG. 4b;

FIG. 4f is a schematic cross-section of the stepped recess shown in the plan view in FIG. 4c;

FIG. 5 schematically highlights different sub-areas of the recess shown already in FIG. 3, together with exemplary thickness removal profiles; and

FIG. 6 is a schematic plan view of another stepped recess in a tire's innerliner, wherein said recess includes a rectangular bottom portion carrying a rectangular sensor comprising a directional antenna.

### DETAILED DESCRIPTION OF THE INVENTION

According to said first aspect, the invention is directed to a tire comprising an innerliner including a surface (or in other words an inner surface), particularly facing a tire cavity, wherein the surface comprises a recess including a depth within a range of 20 μm to 3000 μm and a stepped sidewall. Furthermore, at least one step (preferably at least two steps or each step) of the sidewall of the recess includes a height within a range of 5 μm to 1500 μm. A recess including a stepped sidewall, or, in other words, a stepped recess provided in the innerliner helps to further reduce the probability of small cracks in the innerliner, particularly near the wall of the recess. Thus, the probability of potential crack initiation and/or crack propagation can be further reduced. Prior art processes do not provide stepped recess walls which may result in higher stresses near the relatively high and steep wall of the recess.

In one embodiment, the recess includes a depth (or in other words height) within a range of 20 μm to 1000 μm, preferably within a range of 25 μm to 200 μm, or even more preferably within a range of 30 μm to 100 μm.

In another embodiment, the recess includes at least one step, or preferably at least two steps, or even more preferably at least three steps. Preferably, the recess includes at most 10 steps, more preferably at most 5 steps, or even more preferably at most 4 steps. Steps may be counted from a bottom of the recess. Depths and/or heights are measured herein perpendicular to the surface at a position of the recess. Widths and/or diameters of the recess, or parts thereof, are measured in parallel to said surface comprising the recess. Measurements can be carried out by known micromechanical or microscopical methods, optionally by preparing a cross-section of surface including the recess.

In still another embodiment, at least one step, at least two steps, a majority of the steps, or each step of the stepped sidewall includes a height within a range of 10 μm to 500 μm, or 10 μm to 200 μm, or 10 μm to 50 μm, or preferably within a range of 10 μm to 30 μm. For instance, in case of multiple steps including a height within one of the above ranges means that each one of these multiple steps includes a (step) height within said range.

In still another embodiment, the recess includes a maximum diameter, measured at the surface of the innerliner, within a range of 20 mm to 80 mm, preferably 30 mm to 70 mm.

In still another embodiment, the recess includes a minimum diameter within a range of 10 mm to 60 mm, preferably 20 mm to 50 mm. Diameters are measured herein in a lateral direction, in parallel to the (outermost) surface of the innerliner, or the inner surface of the tire respectively, in an area of the recess. In case the recess has different diameters or a varying diameter, a minimum diameter is the smallest diameter which can be measured and a maximum diameter is the largest diameter that can be measured in parallel to the surface of the innerliner.

In still another embodiment, the recess includes a bottom portion (or bottom) at least partially or fully surrounded by the stepped sidewall. Optionally, one or more of a sensor and a sensor container is attached to the bottom portion of the recess. In other words, the sensor or sensor container preferably does not laterally extend onto one or more of the steps. The sensor container optionally carries a sensor.

In another embodiment, the sensor container is an RFID tag.

In still another embodiment, the sensor container comprises or consists of a polymer composition (such as a polyurethane composition or an elastomer composition, e.g., a rubber composition). In addition, or alternatively, the sensor container is attached to the bottom portion of the recess via an adhesive.

In still another embodiment, said elastomer composition (such as a rubber composition) comprises one or more of rubber (such as comprising one or more of natural rubber, synthetic polyisoprene, butadiene rubber, styrene-butadiene rubber, and butyl rubber), a filler (such as comprising one or more of carbon black and silica), resin (such as a hydrocarbon resin selected from one or more of coumarone-indene resins, petroleum hydrocarbon resins, terpene resins, styrene/alphamethylstyrene resins, terpene phenol resins, rosin derived resins and copolymers and/or mixtures thereof), accelerators, antidegradants, oils, liquid diene based polymers, coupling agents (such as carbon black coupling agents and/or silanes), sulfur donors, and sulfur. Liquid means herein that a material is in a liquid state at 23° C. The composition may be a sulfur-curable or sulfur-cured rubber composition. For instance, the inner surface and/or an attachment surface of the sensor or sensor container may comprise and/or consist of such a composition, wherein the attachment surface is the surface of the sensor or sensor container attached to the inner surface of the tire. Optionally, elastomer compositions, such as rubber compositions may be cord and/or fiber reinforced.

In still another embodiment, said elastomer composition comprises and/or is based on a thermoplastic elastomer, such as a thermoplastic polyester elastomer. Optionally, one or more of said attachment surface, the container, and the sensor container comprises, is formed of, or consists of such a composition.

In still another embodiment, said polymer composition is chosen from an elastomer composition (e.g., as mentioned herein above) and a polyurethane based composition.

In still another embodiment, each of the steps of the stepped sidewall at least partially laterally surrounds the bottom of the recess, and optionally each lower step.

In still another embodiment, at least one step, preferably each step, includes one or more of a ring shape and an ellipsoidal shape, (laterally) surrounding the bottom portion of the recess.

In still another embodiment, at least one step, preferably each step, (laterally) surrounds the bottom portion of the recess in an essentially rectangular shape. This can be of particular advantage if a sensor or sensor container to be mounted to the bottom portion is not rotation symmetric, and/or includes a receiver and/or transmitter, such as an antenna, which are directional. In such a case, the shape of the bottom portion or the steps can help to ensure a correct directional mounting of the sensor or sensor container on the bottom portion so as to provide a correctly directed sensor, particularly receiver and/or transmitter of the sensor.

In still another embodiment, the steps of the stepped wall have predominantly a curved shape at least partially surrounding a bottom portion of the recess.

In still another embodiment, said sensor or sensor container includes an attachment surface attached to the bottom of the recess, wherein the attachment surface includes essentially one or more of a circular, an ellipsoidal, and a curved shape.

In still another embodiment, said sensor or sensor container includes an attachment surface attached to the bottom of the recess, wherein the attachment surface includes essentially a rectangular shape.

In still another embodiment, the bottom portion of the recess is essentially flat or flat.

In still another embodiment, the tire is a cured tire.

In the second aspect, the invention is directed to a method of making and/or processing a tire (particularly, processing an inner surface of the tire), wherein an inner surface, such as the surface of an innerliner, of the tire is formed by an elastomer composition (preferably a rubber composition). The method comprises (a method step of) creating a stepped recess in an area of the inner surface, wherein creating the recess further comprises (a method sub-step of) removing a first thickness of the elastomer composition in a first subarea of the area of the inner surface, and (another method sub-step of) removing a second thickness of the elastomer composition in a second subarea of the area of the inner surface. Furthermore, the second subarea at least partially (laterally) overlaps with the first subarea in an overlapping zone. Thus, in the overlapping zone a third thickness of the elastomer composition is removed as a result, such as the sum, of removing the first thickness and the second thickness.

The second aspect provides a multistep process which allows to create a stepped recess by, e.g., sequentially, removing elastomer composition material. Optionally, the method includes further method steps of removing elastomer composition to create further steps of the recess, or the sidewall of the recess, respectively. By removing the first thickness and removing the second thickness, one step is created between the inner surface of the tire and the bottom of the recess and/or the overlapping zone. The present method, and optionally one or more of its embodiments, may be used to make, or in making, the tire according to the first aspect or one or more of its embodiments.

In one embodiment, said one of the first and the second subareas is smaller than the other one of the first and the second subareas and is optionally (e.g., fully and/or laterally) surrounded by the other one of the first and second subareas, optionally, so that the one of the first and the second subareas being smaller than the other one of the first and the second subareas corresponds to the overlapping zone. In principle, it is possible that elastomer composition in the laterally larger subarea is removed in a first step and in the laterally smaller subarea in a second step. However, it is also possible that the thickness in the laterally smaller subarea is removed first and a thickness in the laterally larger subarea is removed in a second step. For instance, laser ablation could preferably be used in each case, particularly in the latter case.

In another embodiment, the second subarea is laterally shifted in relation to the first subarea and/or only partially overlaps with the first subarea. For instance, it is possible that the first subarea includes a portion which does not overlap with the second subarea, and the second subarea includes also a portion which does not overlap with the first subarea, but both portions have an overlapping zone or area. In other words, each subarea may have a portion which is free of overlap with one or more other subareas.

In still another embodiment, the inner surface of the tire is a surface of an innerliner of the tire, which preferably faces a tire cavity of the tire.

In still another embodiment, said removing is carried out by laser ablation.

In still another embodiment, said removing is carried out by a subtractive technique, such as one or more of laser ablation, mechanical abrasion, and chemical reaction (e.g., etching).

In still another embodiment, the method further comprises (another method sub-step of) removing at least one further thickness of the elastomer composition in at least one further subarea of the area of the tire surface, wherein the at least one further subarea at least partially (e.g., fully or only partially) overlaps with the first sub-area and the second sub-area in a further overlapping zone. Typically, the further overlapping zone is a portion of the above-mentioned overlapping zone. Thus, in the further overlapping zone, a further thickness of the elastomer composition is removed, e.g., as a result (e.g., the sum) of removing the first thickness, the second thickness and said further thickness. Optionally, one or more further method steps of removing even further thicknesses of the elastomer composition in even further subareas are possible. Adding such removal steps creates more steps in the wall of the recess.

In still another embodiment, the tire, particularly the recess, includes an overlapping zone including a smallest lateral diameter within a range of 10 mm to 60 mm.

In still another embodiment, the tire and/or the recess includes an overlapping zone including a (total) depth or height within a range of 20 μm to 3000 μm, preferably 30 μm to 200 μm. In particular, it is possible to apply a range already disclosed herein above in relation to embodiments of the first aspect.

In still another embodiment, the tire comprises an innerliner forming the inner surface of the tire, wherein the innerliner includes a maximum thickness within a range of 300 μm and 4000 μm, preferably within a range of 300 μm to 1200 μm, measured perpendicularly to the surface of the innerliner. Preferably, the thickness of the innerliner is larger than the depth of the recess, wherein the thickness of the innerliner is measured perpendicular to the surface of the innerliner.

In still another embodiment, said first thickness is within a range of 5 μm to 1500 μm, preferably within a range of 10 μm to 200 μm, or more preferably within a range of 10 μm to 50 μm, and/or a second thickness is within a range of 5 μm to 1500 μm, preferably within a range of 10 μm to 200 μm, or more preferably within a range of 10 μm to 50 μm.

In still another embodiment, at least one step of the recess or of the recess' wall is formed between the overlapping zone and at least one portion of the first and second subareas outside of the overlapping zone. It is noted that a recess including merely one straight wall, such as a wall extending perpendicularly from a surface of an innerliner to the bottom of such a recess, is not considered to be stepped or to have a sidewall with at least one step. In this case, the wall of such a recess is considered to have no step.

In still another embodiment, one or more of, preferably each one of, the first subarea, the second subarea, and optionally one or more further subareas, have one or more of a circular shape, an elliptical shape, and a curved shape.

In still another embodiment, one or more of the first subarea, the second subarea, one or more further subareas, the overlapping zone, and the bottom portion have an essentially rectangular shape. Preferably, the bottom portion formed by the adjacent step includes a rectangular shape. Optionally, one or more of a sensor and a sensor container is mounted to the bottom portion, wherein the said sensor and/or sensor container includes an essentially rectangular shape and/or attachment portion. Said mounting is preferably carried out essentially in parallel to the rectangular shape of the bottom portion. Optionally, said sensor comprises one or more of a directional receiver and directional transmitter, such as a directional antenna. Mounting the sensor in a determined orientation relative to the bottom portion helps to provide a correct orientation of the directional receiver and/or directional transmitter of the sensor.

In still another embodiment, one or more of, preferably each one of, the first subarea, the second subarea, and optionally one or more further subareas, have one or more of a circular shape, an elliptical shape, and predominantly a curved shape. In other words, predominantly means that an outline of the respective shape is predominantly curved (it may have one or more corners though).

In still another embodiment, the overlapping zone includes one of a circular shape, an elliptical shape, a curved shape, and a predominantly curved shape.

In still another embodiment, one or more of the first subarea and the second subarea have a minimum diameter within a range of 20 mm to 70 mm.

In still another embodiment, removing the first thickness and/or removing the second thickness is carried out with a bi-directional laser, wherein optionally the bi-directional laser moves line by line (or, in other words, in parallel lines) to ablate each subarea.

In still another embodiment, the laser removes a line of the first thickness when moving in one orientation and removes a parallel line of the second thickness when moving in an orientation opposite to the first orientation.

In still another embodiment, the first subarea and the second subarea are laterally shifted by starting the laser at the beginning of each line with a delay.

In still another embodiment, an absolute amount of the first thickness essentially corresponds to an absolute amount of the second thickness, and/or wherein an absolute amount of the third thickness essentially corresponds to the sum of the absolute amounts of the first thickness and the second thickness.

In still another embodiment, the overlapping zone corresponds to at least 50%, preferably at least 66%, of an area of the first subarea and at least 50%, preferably at least 66%, of an area of the second subarea, respectively.

In still another embodiment, the tire is a cured tire and/or the method further comprises the method step of mounting one or more of a sensor container and a sensor onto a bottom of the overlapping zone.

In still another embodiment, the container or sensor comprises an attachment surface comprising a polymer composition, wherein the container or sensor is attached with the attachment surface, optionally via an adhesive, to the overlapping zone.

In still another embodiment, the adhesive is selected from one or more of a cyano-acrylate adhesive, a solvent based adhesive, an epoxy adhesive, an isocyanate adhesive, a silicone adhesive, a pressure sensitive adhesive, and a polyurethane adhesive. The adhesive may also be present on an adhesive tape, e.g., a double-sided adhesive tape. The adhesive may be considered as a part of the tire.

In still another embodiment, the recess is located at one of a position radially below a tread portion of the tire and on a sidewall portion of the tire.

It is emphasized that the different aspects, embodiments, and features disclosed herein may be combined with one another.

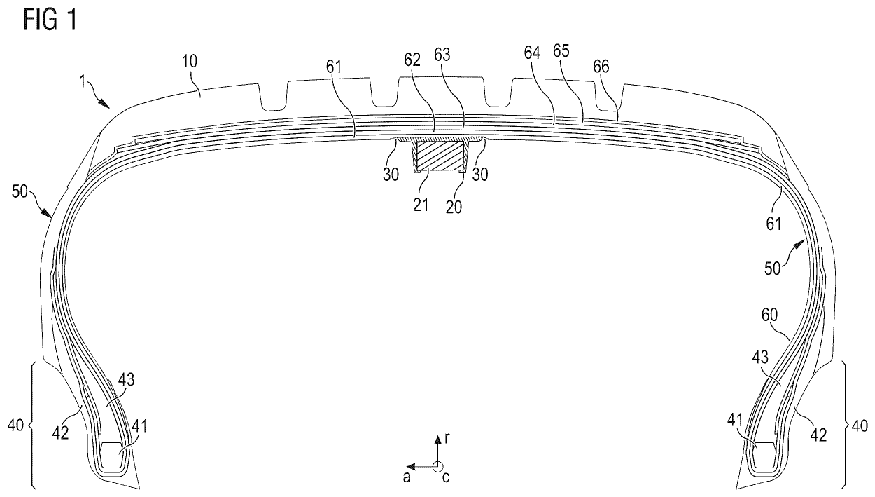

FIG. 1 shows a cross-section of a pneumatic tire 1 in accordance with an embodiment of the present invention. The tire 1 comprises a tread portion 10, two sidewalls 50, and two bead portions 40 each comprising a bead 41, an apex 43 and a chafer 42. Furthermore, the tire 1 comprises an innerliner 61 forming an inner surface 60 of the tire 1 and partially enclosing the tire cavity. The tire 1 also comprises two carcass plies 62, 63 which are folded around each bead 41, as well as two belt plies 64, 65, and an overlay 66 covering the belt plies 64, 65.

In accordance with the present embodiment, the inner surface 60 of the tire 1, or of the innerliner 61, respectively, carries radially below the tread portion 10 and/or the belt plies 64, 65 a sensor container 20 which partially encloses and/or carries a sensor 21. In particular, in the present embodiment, the sensor 21 is held in the container 20 via form fit provided by a flange portion. Such a sensor 21 could, e.g., be or comprise a tire pressure sensor. Optionally, it may have further sensor functions, such as temperature measurement. The sensor container 20 is preferably made of a rubber composition which is attached to or adhered to the innerliner 61 via its attachment surface by an adhesive, such as a cyano-acrylate adhesive. The sensor container 20 and the sensor 21 may be considered together as a sensor container assembly. In the present embodiment, the sensor 21 is mounted into the container 20.

Still in accordance with the present embodiment of the invention, the innerliner 61 includes a stepped recess 30 in its surface, i.e., the inner surface 60. On the one hand, this stepped recess 30 ensures that the sensor container 20 is mounted and adhered to a clean and smooth surface. On the other hand, the stepped sidewall of the recess 30 further reduces the likelihood of elevated strain generated as in case of a perpendicular and high sidewall of a typical recess.

The radial direction r, the circumferential direction c and the axial direction a are indicated in FIG. 1 for the sake of better comprehensibility. The axial direction is in parallel with the axis of rotation of the tire. The circumferential direction c is in parallel to the circumference of the tire and perpendicular to the axial direction a. The radial direction r is also perpendicular to the axial direction and the circumferential direction. It is emphasized that a reference to one of these directions does not necessarily limit those to a certain orientation, unless otherwise indicated herein.

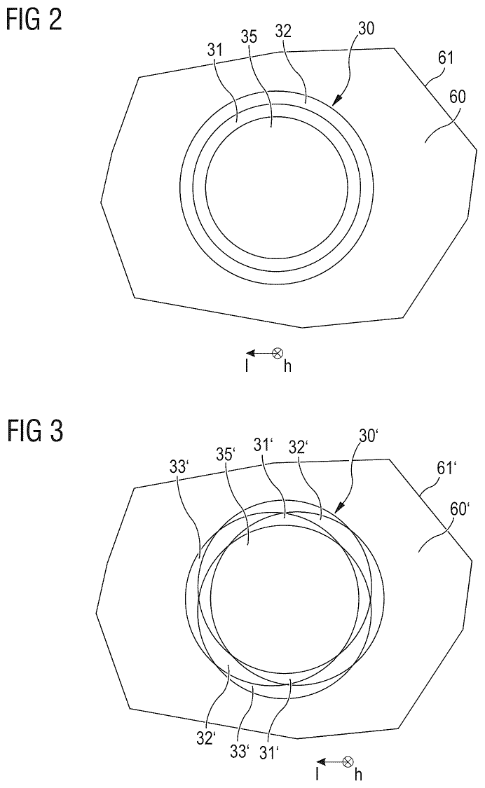

FIG. 2 shows a schematic plan view of the stepped recess 30 already shown in FIG. 1 on the surface 60 of the innerliner 61 of a tire 1, and in the absence of a sensor container and/or sensor. The stepped recess 30 comprises a bottom portion 35 and a first step or step portion 31 as well as a second step or step portion 32. In the present example, the bottom portion 35 includes an essentially circular shape. Although not mandatory, the first step portion 31 concentrically surrounds the bottom portion 35 and the second step portion 32 concentrically surrounds the bottom portion 35 as well as the first step portion 31. The (total) depth or height h of the recess is measured perpendicularly to the inner surface 60 at the bottom portion 35 of the recess 30. The height of a step or step portion can be measured between a foot of the respective step portion and the top of the step portion, still perpendicular to the inner surface 60. The exemplarily depicted lateral direction 1 is essentially perpendicular to the height h and/or extends in parallel to the surface 60. A sensor and/or sensor container could be mounted onto the bottom portion 35 of the recess 30 as shown in FIG. 1 (but not explicitly shown in FIG. 2). It is noted that the relative lateral dimensions of the bottom portion 35 and the step portions 31, 32 are only indicated schematically herein for the sake of better recognizability. In particular, the bottom portion 35 may, e.g., have a lateral diameter in the centimeter range, whereas a lateral width of a step is preferably in the millimeter range or micrometer range, measured perpendicularly to the lateral extension of the step. In one embodiment, the bottom portion 35 includes a diameter within a range of 10 mm to 60 mm, preferably 30 mm to 60 mm, whereas the lateral width of a step is up to 5000 μm, such as within a range of 20 μm to 5000 μm, or preferably 20 μm to 1000 μm. In particular, larger step widths may result in relatively long times to form the steps. Different steps do not need to have the same lateral width and/or height. It is also not required that the lateral width of a step is constant around the bottom portion. Optionally, a step only partially surrounds a lower step and/or the bottom portion. As another option, a step may have a varying width and/or height along its lateral extension.

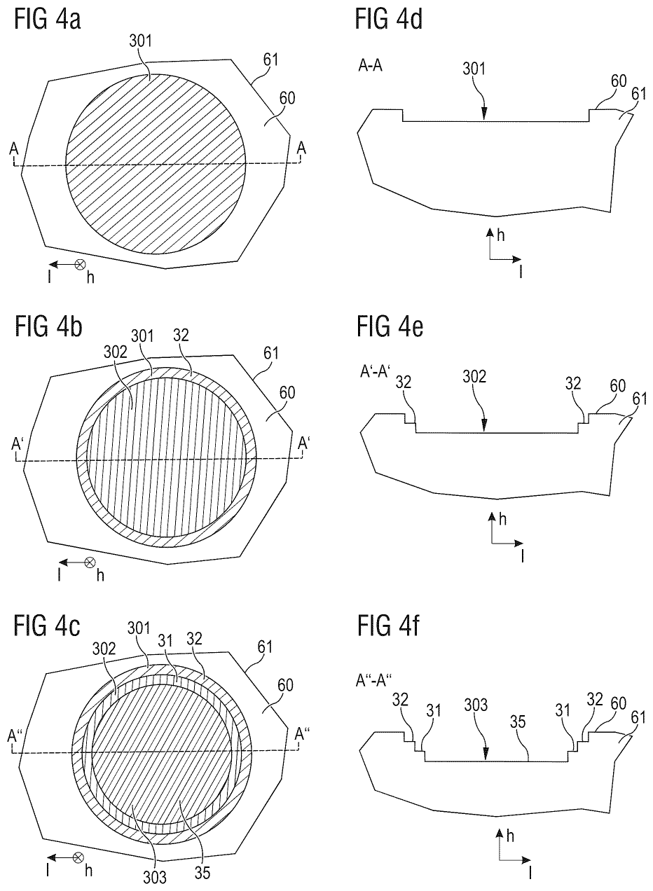

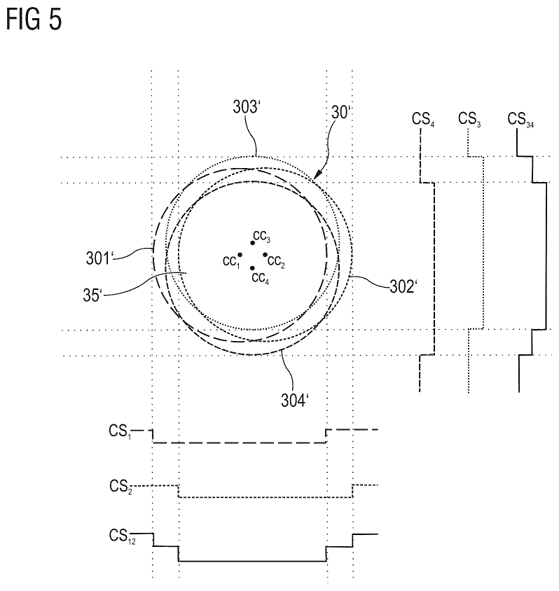

FIGS. 4a to 4f show an embodiment of processing an inner surface of a tire, particularly of creating the stepped recess 30 shown in FIG. 2, by using same reference signs where appropriate. FIG. 4a shows an area of the inner surface 60 of the innerliner 61 which faces the tire cavity. In a first step, a first thickness of innerliner material, in this case rubber composition material, is removed in the first subarea 301. As shown in the corresponding partial cross-sectional view of FIG. 4d, the first thickness of the rubber composition of the innerliner 61 is removed in the first subarea 301, in other words, over the whole first subarea 301. FIG. 4b additionally shows another subarea in which rubber composition material has been removed, i.e., the second subarea 302, which includes a smaller diameter than the first subarea 301 in the present non-limiting embodiment. The second material thickness removed in the second subarea 302 (i.e., over the whole second subarea 302), results in the creation of the step 32. This is further indicated in the corresponding cross-section of FIG. 4c. Thus, the removal of the second material thickness in the second subarea 302 results in the creation of the step or step portion 32. If a further material thickness is removed in a third subarea 303 as shown in FIG. 4c and the corresponding cross-section of FIG. 4f, such a further removal results in the creation of the bottom portion 35 of the recess 30 and another step or step portion 31. In the bottom portion 35 all subareas 301, 302, 303 overlap so that the bottom portion 35 can also be described as overlapping zone (of the subareas). It is noted that the order of removal steps could also be changed, such as reversed. For instance, if using a laser ablation device for removing the rubber composition material of the innerliner 61, any order of removing rubber composition material in the first subarea, the second subarea, and the third subarea would be possible, still essentially resulting in the final cross-section shown in FIG. 4f.

In the embodiment of FIG. 2 and FIGS. 4a to 4f, the steps or step portions 31, 32 surround concentrically the bottom portion 35. In particular, the second subarea 302 is fully covered or overlapped by the first subarea 301 and the third subarea 303 is fully overlapped by the first and/or second subarea 301, 302. However, it is also possible that such subareas do not fully overlap, e.g., one subarea is not fully covered or overlapped by another subarea. An example for such a situation is shown in the embodiment according to FIG. 3 and FIG. 5.

FIG. 3 shows a plan view of another area of an innerliner 61′ including an inner surface 60′ with a recess 30′ which is in accordance with another embodiment of the present invention. The recess 30′ comprises a bottom portion 35′ and multiple steps or step portions 31′, 32′, 33′ which at least partially surround the bottom portion 35′. An example of preparing or creating this recess 30′ is schematically indicated in FIG. 5.

On the one hand, FIG. 5 schematically shows a plan view of the stepped recess 30′ created as a result of removing material thicknesses in four different and partially overlapping subareas 301′, 302′, 303′, and 304′, shown herein with differently dotted lines. In particular, in the present non-limiting example, each subarea 301′, 302′, 303′, and 304′ includes a circular shape. Optionally, other, preferably curved shapes, are also possible. A corresponding center of each of the circular subareas 301′, 302′, 303′, and 304′, is indicated by a respective central dot. In particular, a first circle center cc₁ of the first subarea 301′, a second circle center cc₂ of the second subarea 302′, a third circle center cc₃ of the third subarea 303′, and a fourth circle center cc₄ of the fourth subarea 304′ are shown. On the other hand, FIG. 5 shows exemplary cross-sectional lines of material thickness removal in each sub-area. The first cross-sectional line CS₁ shows an exemplary line of removal of elastomer composition thickness in the first subarea 301′. The second line CS₂ shows another exemplary line of removal of elastomer composition thickness in the second subarea 302′. Both removals according to CS₁ and CS₂ result in a combined removal of material thickness (i.e., thickness of elastomer composition, particularly rubber composition) according to the line CS₁₂ which is essentially the sum of the thickness removals of CS₁ and CS₂. Similarly, the cross-sectional line CS₃ shows the material removal in a line of the third subarea 303′ and the cross-sectional line CS₄ shows the removal of material thickness along a line in the fourth subarea 304′. In portions where the subareas 303′ and 304′ overlap, both material thicknesses are removed, such as indicated in the superposition of cross-section CS₃₄, which is a combination of cross-sections CS₃ and CS₄. It is noted that it is possible to remove material in the four subareas 301′, 302′, 303′, and 304′ in any order. As a preferred example, it is possible to use a laser, such as a bidirectional laser to ablate the rubber material. In the present non-limiting example, a fiber laser has been used, as an YLP fiber laser of the company IPG Photonics™, USA. Optionally, it is possible to create two of said subareas, such as the first subarea 301′ and the second subarea 302′ in one process step. For instance, the circular first and second subareas 301′ and 302′ may be created by said bi-directional laser with a switch-on and/or switch-off delay. The laser may move over the circular subarea 301′, or in other words over the circular contour of the subarea 301′, in multiple parallel lines so as to remove the first material thickness over the first subarea 301′. Similarly, the laser may move over the circular subarea 302′ so as to remove the second material thickness over the second subarea 302′. In another option, it is possible that a line or portion of material thickness of the first subarea 301′ is removed when the laser beam is moving in or along a line in a first direction, whereas a line or portion of material thickness of the second subarea 302′ is removed when the laser beam is moving in a direction opposite to the first direction. Preferably, movement of the laser beam in parallel lines in one direction and an opposite direction alternates. To obtain two laterally partially shifted subareas, a switch-on and/or switch-off delay of the laser may be used. In the present example, the laser may be configured to remove material thickness in a circular contour wherein a switch-on and/or switch-off delay of the laser beam results in two partially laterally shifted circular contours (shifted along a direction of the lines).

Similarly, it is possible to create the third and the fourth subareas 303′ and 304′. In this case the direction of movement of the laser beam could, e.g., be perpendicular to the direction used for creating the subareas 301′ and 302′. However, this is not necessary. In another option, it is possible that the laser beam follows a cross-hatched or spiral path to create the four subareas. A superposition of all subareas 301′, 302′, 303′, and 304′, typically irrespective of the order of removal of material thickness in these subareas, results in the final recess 30′ shown in FIG. 3. Similar to the embodiment of FIG. 2, it is also possible to remove elastomer composition in the different subareas 301′, 302′, 303′, and 304′ sequentially, i.e., subarea after subarea. The subareas partially overlap and form an overlapping zone of removal of elastomer material, which corresponds to the bottom portion 35′ shown in FIG. 3 and FIG. 5.

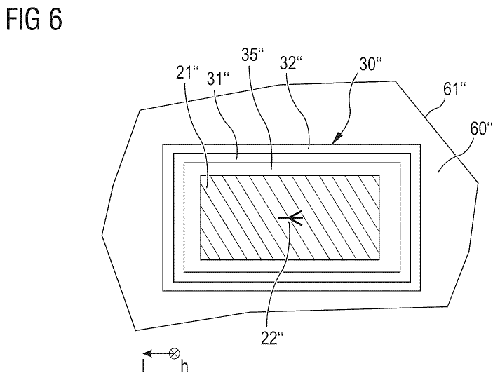

FIG. 6 shows another schematic plan view of a recess 30″ formed on the surface 60″ of an innerliner 61″. In the present embodiment, the recess 30″ includes two steps or step portions 31″ and 32″ which surround with rectangular shapes a rectangular bottom portion 35″ of the recess 30″. A sensor 21″ is mounted to the bottom portion 35″ of the recess 30″. In particular, the sensor 21″ is arranged in parallel to the rectangular shape of the adjacent step portion 31″. In this example, the sensor 21″ carries a directional antenna 22″. The rectangular shape of the bottom portion 35″ and/or one or more of the step portions 31″ and 32″ helps to align the antenna 22″ of the sensor 21″ in a determined orientation on the innerliner 61″.

Providing a stepped recess on an inner surface of a tire, helps to provide a smoother transition between the inner surface of the tire and a bottom of the recess. Sharp and/or very deep edges can be reduced or avoided. Potential strains and/or stresses are also reduced and a probability of an initiation and/or propagation of small cracks in the innerliner is further limited. Furthermore, efficient, particularly cost-efficient, methods have been disclosed for preparing such stepped recesses.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising an innerliner including a surface facing a tire cavity, wherein the surface comprises a recess including i) a depth within a range of 20 μm to 3000 μm and ii) a stepped sidewall, and wherein at least one step of the sidewall includes a height within a range of 5 μm to 1500 μm.

2. The tire according to claim 1, wherein the recess includes a depth within a range of 30 μm and 200 μm and wherein the step includes a height within a range of 10 μm to 50 μm.

3. The tire according to claim 1, wherein the recess includes a maximum diameter, measured at the surface of the innerliner, within a range of 20 mm and 80 mm and a minimum diameter within a range of 10 mm and 60 mm.

4. The tire according to claim 1, wherein the recess includes a bottom portion surrounded by the stepped sidewall and wherein one or more of a sensor and a sensor container are attached to the bottom of the recess.

5. A method of processing a tire, comprising creating a stepped recess in an area of an inner surface of the tire, wherein the inner surface is formed by an elastomer composition, and wherein creating the stepped recess comprises:
removing a first thickness of the elastomer composition in a first subarea of the area of the inner surface; and
removing a second thickness of the elastomer composition in a second subarea of the area of the inner surface, wherein the second subarea at least partially overlaps with the first subarea in an overlapping zone so that in the overlapping zone a third thickness of the elastomer composition is removed as result of removing the first thickness and the second thickness.

6. The method according to claim 5, wherein one of the first and the second subareas is smaller than the other one of the first and the second subareas and is surrounded by the other one of the first and second subareas, so that the one of the first and the second subareas being smaller than the other one of the first and the second subareas corresponds to the overlapping zone.

7. The method according to claim 5, wherein the second subarea is laterally shifted in relation to the first subarea and only partially overlaps with the first subarea.

8. The method according to claim 5, wherein the inner surface of the tire is a surface of an innerliner of the tire which faces a tire cavity of the tire.

9. The method according to claim 5, wherein said removing is carried out by laser ablation.

10. The method according to claim 5, wherein the method further comprises removing at least one further thickness of the elastomer composition in at least one further subarea of the area of the tire surface, wherein the at least one further subarea at least partially overlaps with the first sub-area and the second sub-area in a further overlapping zone so that in the further overlapping zone a further thickness of the elastomer composition is removed as a result of removing the first thickness, the second thickness and the further thickness.

11. The method according to claim 5, wherein the tire includes one of:
an overlapping zone including a smallest lateral diameter within a range of 10 mm to 60 mm;
an overlapping zone including a total depth within a range of 20 μm to 3000 μm;
an innerliner forming the inner surface of the tire, wherein the innerliner includes a maximum thickness within a range of 300 μm to 4000 μm, being larger than a total depth of the stepped recess; and
a first thickness within a range of 5 μm to 1500 μm and a second thickness within a range of 5 μm to 1500 μm.

12. The method according to claim 5, wherein at least one step is formed between the overlapping zone and at least one portion of the first and second subareas outside of the overlapping zone.

13. The method according to claim 5, wherein each one of the first subarea and the second subarea have one or more of a circular shape, an elliptical shape, and a curved shape.

14. The method according to claim 5, wherein one of the first and the second subareas is smaller than the other one of the first and the second subareas and is surrounded by the other one of the first and second subareas, so that the one of the first and the second subareas being smaller than the other one of the first and the second subareas corresponds to the overlapping zone, and wherein the overlapping zone includes essentially a rectangular shape.

15. The method according to claim 5, wherein one or more of the first subarea and the second subarea have a minimum diameter within a range of 20 mm to 70 mm.

16. The method according to claim 5, wherein removing the first thickness and removing the second thickness is carried out with a bi-directional laser, and wherein the bi-directional laser moves line by line to ablate the elastomer composition in each subarea.

17. The method according to claim 5, wherein the overlapping zone corresponds to at least 50% of an area of the first subarea and at least 50% of an area of the second subarea, respectively.

18. The method according to claim 5, wherein the tire is a cured tire and wherein the method further comprises mounting one or more of a sensor and a sensor container onto a bottom of the overlapping zone.

19. The method according to claim 18, wherein said one or more of sensor and sensor container comprises an attachment surface formed by a polymer composition, and wherein the one or more of sensor or sensor container is attached with the attachment surface, optionally via an adhesive, to the overlapping zone.

20. The method according to claim 18, wherein the recess is located in a position chosen from one of radially below a tread portion of the tire and on a sidewall portion of the tire.
